(19) United States
(12) Patent Application Publication
(10) Pub. No.: US 2026/0233935 A1
(43) Pub. Date: Aug. 13, 2026

(54) MANAGING ROBOTS IN WORKFLOWS

(71) Applicant: APPTRONIK, INC., Austin, TX (US)

(72) Inventor: Barry Phillips, Los Gatos, CA (US)

(21) Appl. No.: 19/469,693

(22) PCT Filed: Apr. 1, 2024
(86) PCT No.: PCT/US2024/022483

§ 371 Date: Sep. 26, 2025

Related U.S. Application Data
(60) Provisional application No. 63/493,152, filed on Mar. 30, 2023.
(60) Provisional application No. 63/616,889, filed on Jan. 2, 2024.

(51) Int. Cl. B65G 1/137; G05D 1/622; G05D 1/667; G05D 1/69; G05D 105/20; G05D 107/70; G05D 109/12

(52) U.S. Cl. CPC B65G 1/1373; G05D 1/622; G05D 1/667; G05D 1/69; G05D 2105/20; G05D 2107/70; G05D 2109/12

(57) ABSTRACT

Robotic systems and methods include one or more humanoid robots configured to move within a commercial environment that includes a plurality of commercial products supported by a plurality of donor pallets; one or more autonomous mobile robots (AMRs) configured to move within the commercial environment; and a control system communicably coupled to the one or more humanoid robots and the one or more AMRs. The control system is configured to perform operations comprising commanding a particular AMR to move an order pallet within the commercial environment to a particular donor pallet; and commanding a particular humanoid robot proximate to the particular donor pallet to move at least one commercial product from the particular donor pallet to the order pallet.

### TECHNICAL FIELD

The present disclosure describes systems and methods associated with managing one or more robots in workflows, such as workflows that involve integrating one or more humanoid robots with other autonomous mobile robots in warehouse workflows.

### BACKGROUND

Workflows that conventional include human workers, such as warehouse workflows, can often use certain autonomous robots to replace one, some, or all of the human workers. For example, in a conventional person-to-goods case pick to pallet process, a human leverages a pallet jack, walkie rider, or equivalent pallet transportation equipment to move an order pallet through aisles of pallet racking that contain donor pallets and pick full cases from the donor pallets to build an order pallet. This process requires endless amounts of walking, heavy lifting, and possibly a significant amount of pulling for a complete order pallet to be built by a human. Autonomous Mobile Robots (AMRs) can be used instead of pallet jacks, walkie riders, or equivalent pallet transportation equipment to eliminate the need for a human to walk long distances or pull equipment containing a pallet as that human can now stay in one area and wait for an AMR to bring a pallet to that area, but this does not eliminate the heavy lifting required by a human to build a pallet. Additionally, while a Warehouse Management System (WMS) or Warehouse Execution System (WES) can send the AMR to the proper order of donor pallets to layer the cases correctly (heavy cases on the bottom as an example), each human may not be aware of the cases picked and stacked on the pallet by humans before the AMR comes to his/her area or what cases will be picked and stacked by humans after the AMR leaves his/her area, so a pallet could be built incorrectly.

Also, conventional workflows that include human workers, such as warehouse workflows, can often use certain autonomous robots to replace one, some, or all of the human workers. For example, in a conventional person-to-goods case pick at height process, a human leverages an order picker lift truck or equivalent case pick at height equipment to move through aisles of pallet racking that contain donor pallets at different heights and pick cases or boxes from the donor pallets to either build an order pallet or a receiving pallet of cases or boxes that will be shipped individually or in quantities less than an order pallet. Autonomous Order Picker Lift Trucks can be used instead of conventional human-piloted order picker lift trucks to eliminate the need for a human to drive conventional order picker lift trucks up and down aisles to reach donor pallets at any height in aisles, but this does not eliminate the needs for a human to build a pallet on the autonomous order picker, whether an order pallet or a pallet of cases or boxes that will be shipped individually or in quantities less than an order pallet.

### SUMMARY

In an example implementation, robotic systems and methods include one or more humanoid robots configured to move within a commercial environment that includes a plurality of commercial products supported by a plurality of donor pallets; one or more autonomous mobile robots (AMRs) configured to move within the commercial environment; and a control system communicably coupled to the one or more humanoid robots and the one or more AMRs. The control system is configured to perform operations comprising commanding a particular AMR to move an order pallet within the commercial environment to a particular donor pallet; and commanding a particular humanoid robot proximate to the particular donor pallet to move at least one commercial product from the particular donor pallet to the order pallet.

In an aspect combinable with the example implementation, the operations further comprise commanding the particular AMR to move the order pallet within the commercial environment to another particular donor pallet; and commanding another particular humanoid robot proximate to the another particular donor pallet to move at least one additional commercial product from the another particular donor pallet to the order pallet.

In another aspect combinable with one, some, or all of the previous aspects, the at least one commercial product and the at least one additional commercial product are different.

In another aspect combinable with one, some, or all of the previous aspects, the operations further comprise commanding the particular AMR to move the order pallet within the commercial environment away from the plurality of donor pallets subsequent to the another particular humanoid robot moving the at least one additional commercial product from the another particular donor pallet to the order pallet.

In another aspect combinable with one, some, or all of the previous aspects, at least a portion of the control system is a part of the particular humanoid robot.

In another aspect combinable with one, some, or all of the previous aspects, all of the control system is a part of the particular humanoid robot.

In another aspect combinable with one, some, or all of the previous aspects, at least a portion of the control system is in a head of the particular humanoid robot.

In another aspect combinable with one, some, or all of the previous aspects, each of the one or more humanoid robots comprises a torso and a lower body.

In another aspect combinable with one, some, or all of the previous aspects, the torso comprises two arm appendages, two hand appendages, and a head, and the lower body comprises two leg appendages and two feet appendages.

In another aspect combinable with one, some, or all of the previous aspects, the operations further comprise commanding the particular humanoid robot to stay within an area adjacent the particular donor pallet to avoid a safety field of the particular AMR.

In another aspect combinable with one, some, or all of the previous aspects, the operations further comprise commanding another particular AMR to move another order pallet within the commercial environment to the particular donor pallet; commanding the particular humanoid robot proximate to the particular donor pallet to move at least one commercial product from the particular donor pallet to the another order pallet; commanding the another particular AMR to move the another order pallet within the commercial environment to the another particular donor pallet; and commanding the another particular humanoid robot adjacent the another particular donor pallet to move at least one additional commercial product from the another particular donor pallet to the another order pallet.

In another aspect combinable with one, some, or all of the previous aspects, the operations further comprise determining a path of the particular AMR through the commercial environment based on a combination of commercial products specified for the order pallet.

In another aspect combinable with one, some, or all of the previous aspects, the operation of determining the path comprises determining a first commercial product of the combination of commercial products based on a weight or size of the first commercial product; and determining a second commercial product of the combination of commercial products based on a weight or size of the second commercial product that is less than the weight or size of the first commercial product.

In another aspect combinable with one, some, or all of the previous aspects, the operations further comprise: (i) commanding the particular AMR to move the order pallet along the path within the commercial environment to the donor pallet that supports the first commercial product.

In another aspect combinable with one, some, or all of the previous aspects, the operations further comprise: (ii) commanding the humanoid robot adjacent the donor pallet that supports the first commercial product to move at least one first commercial product to the order pallet.

In another aspect combinable with one, some, or all of the previous aspects, the operations further comprise: (iii) subsequent to (ii), commanding the particular AMR to move the order pallet along the path within the commercial environment to the donor pallet that supports the second commercial product.

In another aspect combinable with one, some, or all of the previous aspects, the operations further comprise: (iv) commanding the humanoid robot adjacent the donor pallet that supports the second commercial product to move at least one second commercial product to the order pallet.

In another example implementation, a robotic system includes one or more humanoid robots configured to move within a commercial environment that includes a plurality of commercial products supported by a plurality of donor pallets; at least one autonomous order picker lift truck configured to move within the commercial embodiment; and a control system communicably coupled to the one or more humanoid robots and the one or more autonomous order picker lift trucks. The control system is configured to perform operations comprising commanding the autonomous order picker lift truck to move a particular humanoid robot adjacent a particular donor pallet that is mounted on a rack assembly at or above a support surface of the commercial environment; commanding the autonomous order picker lift truck to move the particular humanoid robot to a vertical height at or near the particular donor pallet; and commanding the particular humanoid robot to pick a commercial product or a case from the particular donor pallet and place the picked commercial product or case to an order pallet or receiving pallet.

In an aspect combinable with the example implementation, the at least one autonomous order picker lift truck is at least one of an autonomous mobile robot (AMRs) or an autonomous guided vehicle (AGV).

In another aspect combinable with one, some, or all of the previous aspects, the operations further include commanding the particular humanoid robot to position itself on the autonomous order picker lift truck.

In another aspect combinable with one, some, or all of the previous aspects, the operations further include commanding the particular humanoid robot to position itself on a platform of the autonomous order picker lift truck on which the order pallet is positioned.

In another aspect combinable with one, some, or all of the previous aspects, the operations further include commanding the autonomous order picker lift truck to move the particular humanoid robot adjacent another particular donor pallet that is mounted on the rack assembly at or above the support surface of the commercial environment; commanding the autonomous order picker lift truck to move the particular humanoid robot to another vertical height at or near the another particular donor pallet that is different than the vertical height at or near the particular donor pallet; and commanding the particular humanoid robot to pick another commercial product or another case from the another particular donor pallet and place the picked another commercial product or case to the order pallet or receiving pallet.

In another aspect combinable with one, some, or all of the previous aspects, the at least one commercial product and the another commercial product are different.

In another aspect combinable with one, some, or all of the previous aspects, at least a portion of the control system is a part of at least one of the one or more humanoid robots.

In another aspect combinable with one, some, or all of the previous aspects, all of the control system is a part of at least one of the one or more humanoid robots.

In another aspect combinable with one, some, or all of the previous aspects, at least a portion of the control system is in a head of at least one of the one or more humanoid robots.

In another aspect combinable with one, some, or all of the previous aspects, each of the one or more humanoid robots includes a torso and a lower body.

In another aspect combinable with one, some, or all of the previous aspects, the torso includes two arm appendages, two hand appendages, and a head, and the lower body includes two leg appendages and two feet appendages.

In another aspect combinable with one, some, or all of the previous aspects, the operations further include commanding a second autonomous order picker lift truck to move another particular humanoid robot adjacent a second particular donor pallet that is mounted on the rack assembly at or above the support surface of the commercial environment; commanding the second autonomous order picker lift truck to move the another particular humanoid robot to a second vertical height at or near the second particular donor pallet; and commanding the another particular humanoid robot to pick a second commercial product or case from the second particular donor pallet and place the picked second commercial product or case to a second order pallet or receiving pallet.

In another aspect combinable with one, some, or all of the previous aspects, the operations further include determining a path of the autonomous order picker lift truck through the commercial environment based on a combination of commercial products specified for the order pallet or receiving pallet; and determining a picking order of the commercial products specified in the order pallet based on one or more heights within the rack assembly at which the commercial products are located.

In another aspect combinable with one, some, or all of the previous aspects, the operation of determining the path includes determining a first commercial product of the combination of commercial products based on at least one of the one or more heights, a weight, or a size of the first commercial product; and determining a second commercial product of the combination of commercial products based on at least one of the one or more heights, a weight, or a size of the second commercial product.

In another example implementation, a computer-implemented method includes registering, with a control system, one or more humanoid robots within a commercial environment that includes a plurality of commercial products supported by a plurality of donor pallets; registering, with the control system, at least one autonomous order picker lift truck configured to move within the commercial environment; commanding, with the control system, the autonomous order picker lift truck to move a particular humanoid robot adjacent a particular donor pallet that is mounted on a rack assembly at or above a support surface of the commercial environment; commanding, with the control system, the autonomous order picker lift truck to move the particular humanoid robot to a vertical height at or near the particular donor pallet; and commanding, with the control system, the particular humanoid robot to pick a commercial product or a case from the particular donor pallet and place the picked commercial product or case to an order pallet or receiving pallet.

An aspect combinable with the example implementation further includes commanding, with the control system, the particular humanoid robot to position itself on the autonomous order picker lift truck.

Another aspect combinable with one, some, or all of the previous aspects further includes commanding, with the control system, the particular humanoid robot to position itself on a platform of the autonomous order picker lift truck on which the order pallet is positioned.

Another aspect combinable with one, some, or all of the previous aspects further includes commanding, with the control system, the autonomous order picker lift truck to move the particular humanoid robot adjacent another particular donor pallet that is mounted on the rack assembly at or above the support surface of the commercial environment; commanding, with the control system, the autonomous order picker lift truck to move the particular humanoid robot to another vertical height at or near the another particular donor pallet that is different than the vertical height at or near the particular donor pallet; and commanding, with the control system, the particular humanoid robot to pick another commercial product or another case from the another particular donor pallet and place the picked another commercial product or case to the order pallet or receiving pallet.

In another aspect combinable with one, some, or all of the previous aspects, the at least one commercial product and the another commercial product are different.

In another aspect combinable with one, some, or all of the previous aspects, each of the one or more humanoid robots includes a torso and a lower body.

In another aspect combinable with one, some, or all of the previous aspects, the torso includes two arm appendages, two hand appendages, and a head, and the lower body includes two leg appendages and two feet appendages.

Another aspect combinable with one, some, or all of the previous aspects further includes commanding, with the control system, a second autonomous order picker lift truck to move another particular humanoid robot adjacent a second particular donor pallet that is mounted on the rack assembly at or above the support surface of the commercial environment; commanding, with the control system, the second autonomous order picker lift truck to move the another particular humanoid robot to a second vertical height at or near the second particular donor pallet; and commanding, with the control system, the another particular humanoid robot to pick a second commercial product or case from the second particular donor pallet and place the picked second commercial product or case to a second order pallet or receiving pallet.

Another aspect combinable with one, some, or all of the previous aspects further includes determining, with the control system, a path of the autonomous order picker lift truck through the commercial environment based on a combination of commercial products specified for the order pallet; and determining, with the control system, a picking order of the commercial products specified in the order pallet based on one or more heights within the rack assembly at which the commercial products are located.

In another aspect combinable with one, some, or all of the previous aspects, determining the path includes determining, with the control system, a first commercial product of the combination of commercial products based on at least one of the one or more heights, a weight, or a size of the first commercial product; and determining, with the control system, a second commercial product of the combination of commercial products based on at least one of the one or more heights, a weight, or a size of the second commercial product.

Implementations of systems and methods according to the present disclosure can include one, some, or all of the following features. For example, implementations according to the present disclosure can eliminate or reduce a need for humans to mount lift trucks to reach product at height, and lift in a warehouse workflow. Also, implementations according to the present disclosure can help prevent or avoid injuries of humans that work at height in a case picking process. As another example, implementations that utilize a humanoid robot for case pick-to-pallet workflows can help reduce labor turnover and overall labor costs as well as result in a reduction of workers' compensation claims and time away from work due to injury to picking heavy cases from donor pallets and placing these heavy cases on order pallets, as well as picking cases at a height above a finished floor.

Implementations of systems and methods according to the present disclosure can also include one, some, or all of the following features. For example, implementations according to the present disclosure can eliminate or reduce a need for humans to walk long distances, lift and move heavy cases or commercial product, and pull pallet transportation equipment in a warehouse workflow. As another example, implementations according to the present disclosure can ensure that cases or commercial product are layered in a proper order on order pallets to ensure heavier cases are beneath lighter cases, or a pallet is built in a “store-friendly” manner. As another example, implementations that utilize a humanoid robot for case pick-to-pallet workflows can help reduce labor turnover and overall labor costs as well as result in a reduction of workers' compensation claims and time away from work due to injury to picking heavy cases from donor pallets and placing these heavy cases on order pallets.

The details of one or more implementations of the subject matter described in this disclosure are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic illustration of an example implementation of a workflow in a commercial environment that includes autonomous mobile robots and humanoid robots according to the present disclosure.

FIGS. 2A and 2B are example implementations of a humanoid robot according to the present disclosure.

FIG. 3 is a schematic illustration of a view from a workflow control system in a commercial environment that includes autonomous mobile robots and humanoid robots according to the present disclosure.

FIG. 4 is a schematic illustration of a view from a humanoid robot in a workflow in a commercial environment according to the present disclosure.

FIG. 5 is a schematic illustration of an example implementation of a workflow in a commercial environment that includes autonomous mobile robots and humanoid robots according to the present disclosure.

FIGS. 6 and 7 are schematic illustrations of views of a commercial environment that includes an autonomous mobile robot and a vertically elevated humanoid robot in a case picking workflow according to the present disclosure.

FIG. 8 shows a schematic drawing of a control system that can be used in the workflows of FIGS. 1 and 5 according to the present disclosure.

### DETAILED DESCRIPTION

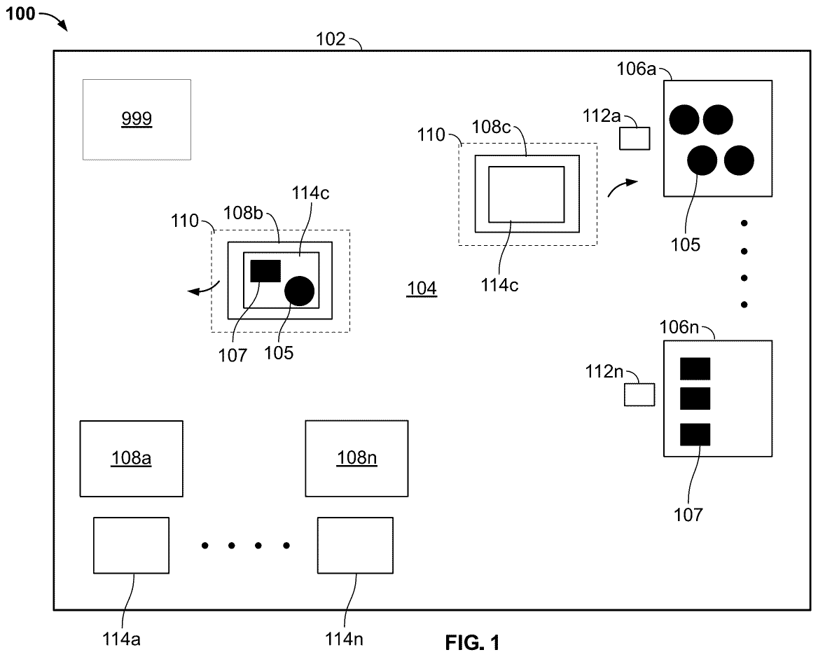

FIG. 1 is a schematic illustration of an example implementation of a workflow in a commercial environment 100 that includes autonomous mobile robots (including autonomous guided vehicles) and humanoid robots according to the present disclosure. For example, commercial environment 100 can be a warehouse (in any industry) or other facility (construction warehouse, shipping center, packaging center, warehouse, distribution or fulfillment center, manufacturing facility or otherwise) in which one or more commercial products (i.e., products sold or otherwise transferred in commerce) are gathered and stored (at least transiently) and arranged in combinations for sale, shipping, further distribution channels, or packaging. The workflow illustrated and described in FIG. 1 can represent a case pick-to-pallet process that integrates humanoid robots 112a-n and autonomous mobile robots (AMRs) 108a-n to solve existing issues with existing case pick-to-pallet processes regardless of if those processes leverage humans along with pallet jacks, walkie riders, or other pallet transportation equipment, or leverage humans along with AMRs. The example workflow that integrates humanoid robots 112a-n and AMRs 108a-n can eliminate or reduce a need for humans to walk long distances, lift and move heavy cases, and pulling pallet transportation equipment while also ensuring that cases are layered in the proper order on order pallets.

As shown in FIG. 1, commercial environment 100 (such as a warehouse) includes or encloses an occupiable volume 104 in a building structure 102. The volume 104 can store donor pallets 106a-n (with “n” representing a variable number according to the present disclosure), for example, on a ground surface, pallet racking, or shelving. Each donor pallet 106a-n can enclose, contain, or otherwise support one or more commercial products. In some aspects, each donor pallet 106a-n supports a particular, unique commercial product (e.g., in a large quantity). For example, as shown, donor pallet 106a supports commercial products 105, while donor pallet 106n supports commercial products 107. There can be as many donor pallets 106a-n and commercial products as desired or necessary.

As shown in this example, one or more humanoid robots 112a-n are positioned in the volume 104, such as proximate to (e.g., within 1 ft., 2 ft., 3 ft., 4 ft., 5-10 ft., or otherwise) the donor pallets 106a-n. In some aspects, there can be a one-to-one ratio of humanoid robots 112a-n to donor pallets 106a-n. Alternatively, there can be more humanoid robots 112a-n than donor pallets 106a-n (e.g., more than one humanoid robot 112a-n can be positioned adjacent or assigned to a particular donor pallet 106a-n). Alternatively, there can be fewer humanoid robots 112a-n than donor pallets 106a-n (e.g., a particular humanoid robot 112a-n can be positioned adjacent or assigned to more than one donor pallet 106a-n). Generally, each humanoid robot 112a-n is operable to move to remove one or more commercial products from a particular donor pallet 106a-n (or more than one donor pallet) and, as described herein, place the removed commercial product(s) onto an order pallet.

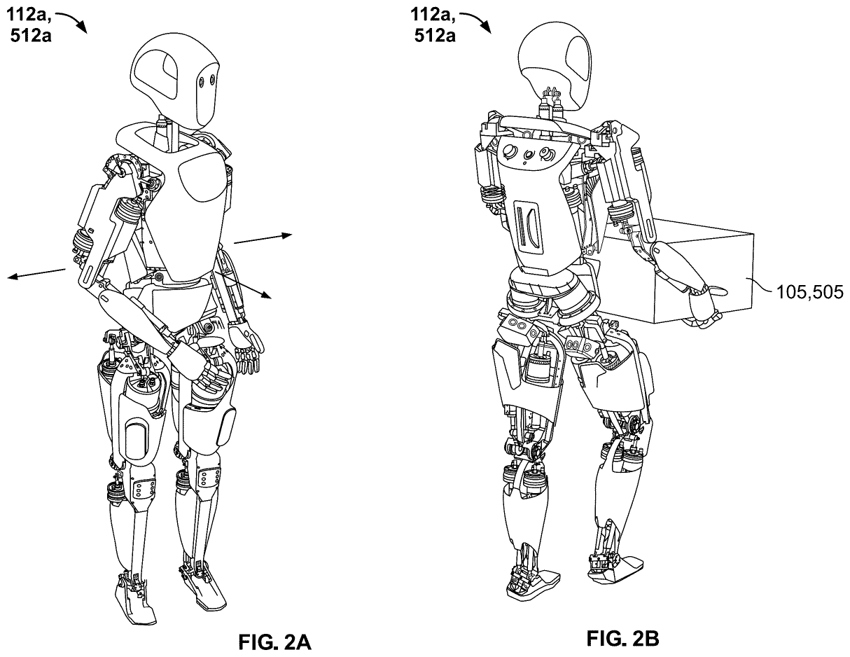

Turning briefly, to FIGS. 2A and 2B, these figures illustrate example implementations of a humanoid robot 112a (and humanoid robot 512a) according to the present disclosure. As shown, the humanoid robot 112a can include a torso and lower body, with appendages (e.g., legs, feet, arms, hands, head) that mimic or otherwise resemble and functional similarly to the corresponding human body appendages. The humanoid robot 112a can include multifunction movement, such as: walking, squatting, bending at waist, kneeling, torso rotation, head rotation, lifting (from ground, to torso height, above head), carrying (e.g., commercial product 105 as shown in FIG. 2B) as well as other movements that mimic human natural movement). In addition, in some aspects, the humanoid robot 112a can include visual image sensing and recognition (e.g., built into the head or otherwise), radar, or lidar to detect objects within its path. As such, the humanoid robot 112a can be distinguished from the AMRs 108a-n, which can have movement capability (e.g., through wheels, tracks, rollers, or other non-humanlike apparatus) but do not include humanlike appendages. Example AMRs 108a-n can be, for example robots made by Fetch Robotics, Mobile Industrial Robots, OTTO Robotics or otherwise.

In this example, one or more AMRs 108a-n are also positioned in the volume 104 and operable to move throughout the volume 104 to receive commercial products (105, 107, or others) onto order pallets 114a-n. In this example, each AMR 108a-n can include an order pallet or otherwise have an order pallet 114a-n placed onto the AMR (either by its own actions or by a human operator). Each order pallet 114a-n can have a specified or predetermined quantity and type of commercial products to be placed on the order pallet according to a commercial transaction that has been (or will be) completed. As shown in this example, each AMR 108a-n includes a safety field 110, which represents a volume surrounding the particular AMR into which other objects (such as humanoid robots 112a-n) should not enter (e.g., for safety or other reasons).

In this example workflow, the commercial environment 100 can include a Warehouse Management System (WMS) 999 that can, in some aspects, include, interface with, or incorporate a Warehouse Execution System (WES), a Warehouse Control System (WCS), and/or WES (or pick path optimization) functionality. Other functionality can be included with or interface with the WMS 999, such as cubing (or so-called “Tetris”) functionality, which allows the WMS 999 to instruct the humanoid robots 112a-n how and in what order to place product on one or more pallets (e.g., based on size and/or weight of the product, an order of removal of the product from the pallet such as last on-first off, an arrangement of the unloaded product within a store or other commercial enterprise, or a combination thereof).

The WMS 999, WES or WCS can be, for example, a microprocessor based control system that controls the operations of the humanoid robots 112a-n and AMRs 108a-n according to software instructions executable by the WMS 999, WES or WCS. In some aspects, the WMS 999, WES or WCS controls operations of the humanoid robots 112a-n and AMRs 108a-n to move commercial products (105, 107, and others) from donor pallets 106a-n to order pallets 114a-n (e.g., in specified quantities and in a specified order of loading) in order to fulfill a commercial transaction or otherwise. In some aspects, WMS 999, WES or WCS can be a physically separate control system that communicates (e.g., wired or wirelessly) with the humanoid robots 112a-n and AMRs 108a-n. Alternatively, some or all of the functionality (e.g., processing capability, memory storage, communications, software instructions) can be located in one or more of the humanoid robots 112a-n (such as, for example, within a head or torso of a humanoid robot). Thus, in some aspects, one or more of the humanoid robots 112a-n can act as the WMS 999 to control the humanoid robots 112a-n and AMRs 108a-n.

In some aspects of an example workflow of commercial environment 100, the WMS 999, WES or WCS can identify or register all of the humanoid robots 112a-n and AMRs 109a-n within the volume 104 (e.g., in order to determine which of the robots are activated or operable). The WMS 999, WES or WCS can then communicate with AMR 108c and direct AMR 108c toward the donor pallets 106a (e.g., in some cases, subsequent to picking up an empty order pallet 114a-n) in order to load an empty order pallet 114c with commercial products (105, 107, or others) to fulfill a specified transaction. In some aspects, the WMS 999, WES or WCS directs the AMR 108c toward a particular donor pallet 106a-n (and subsequently to other donor pallets 106a-n in a specific order) based on a size or weight (or both) of the commercial product supported on the particular donor pallets 106a-n.

For example, in loading the empty order pallet 114c, it may be beneficial or advantageous to load commercial product heaviest (or largest) to lightest (or smallest) according to cubing functionality built into or interfaced with the WMS 999, WES or WCS. In such aspects, lighter commercial product may not be crushed or damaged by later-loaded and heavier commercial product. In some instances, the WMS can provide one or more AMRs 108a-n and/or one or more humanoid robots 112a-n one or more tasks. In some aspects, such as with the inclusion of cubing functionality, the WMS 999, WES or WCS can instruct, e.g., the humanoid robots 112a-n told to pick multiple cases and place them on a pallet, with a location specificity of placement on the pallet varying depending on the aforementioned criteria.

After the AMR 108c is directed to a particular donor pallet, such as donor pallet 106a to pick up commercial product 105, the WMS 999 controls the humanoid robot 112a at the donor pallet 106a to pick a specific number of commercial product 105 from the donor pallet 106a and place the picked commercial product 105 onto the order pallet 114c. In some aspects, the WMS 999 directs the humanoid robot 112a to remain close to the donor pallet 106a until the AMR 108c has stopped at a specific location to ensure that the humanoid robot 112a does not trigger the safety field 110 of the AMR 108c. In some aspects, the WMS 999 or controller of the humanoid robot 112a (e.g., in the head or torso of the humanoid robot 112a) directs a proper placement of each commercial product 105 on the order pallet 114c to create the correct layers of product on the order pallet 114c. After picking and placing the appropriate number of commercial product 105 in the correct location(s) on the order pallet 114c, the humanoid robot 112a repositions itself close to the donor pallet 106a (e.g., at pallet racking or shelving) so that the AMR 108c can leave the area around the donor pallet 106a without its safety field 110 being triggered.

The above-described operations can be repeated at one or more additional donor pallets 106a-n. For example, the AMR 108c can next be directed to donor pallet 106n to pick up commercial product 107. After picking and placing the appropriate number of commercial product 107 in the correct location(s) on the order pallet 114c, the humanoid robot 112n repositions itself close to the donor pallet 106n (e.g., at pallet racking or shelving) so that the AMR 108c can leave the area around the donor pallet 106n without its safety field 110 being triggered. If the order pallet 114c is complete, the AMR 108c can move the order pallet 114c toward a location in the volume 104 in which the order pallet 114c can be shipped or otherwise packaged (e.g., as shown with AMR 108b moving a completed order pallet 114b).

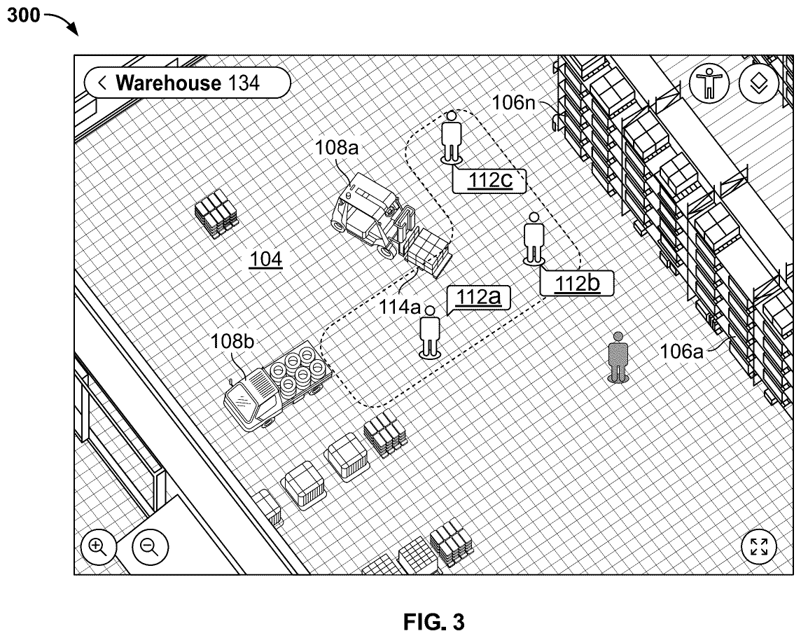

FIG. 3 is a schematic illustration of a view 300 from a workflow control system in a commercial environment that includes autonomous mobile robots and humanoid robots according to the present disclosure. For example, view 300 can be generated by WMS 999 as a workflow (as previously described) to load commercial product on order pallets 114a-n from donor pallets 106a-n by the humanoid robots 112a-n and AMRs 108a-n is completed. In some aspects, the view 300 can be generated by the WMS 999 on a display (that is part of or separate from the WMS 999) that is viewable by a human operator in order to ensure that the workflow is completed correctly. For example, the view 400 can show the locations and movements of the humanoid robots 112a-n and AMRs 108a-n during the workflow, as well as the status of the order pallets 114a-n and donor pallets 106a-n. In some aspects, the WMS 999 can provide for visual inspection and counting of quantities of commercial product supported by each donor pallet 106a-n to ensure that there is sufficient quantity for each product (and order more product if necessary). Further, in some aspects, the WMS 999 can provide for visual inspection and counting of quantities of commercial product loaded on each order pallet 114a-n to ensure that a specified order is completed (with the correct quantity and type of commercial product).

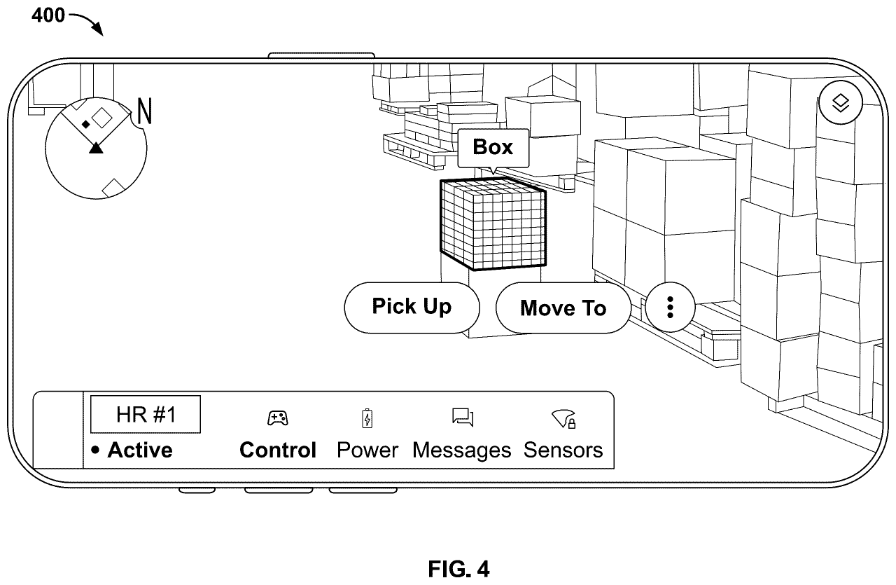

FIG. 4 is a schematic illustration of a view 400 from a humanoid robot in a workflow in a commercial environment according to the present disclosure. For example, as described, each humanoid robot 112a-n can include visual receptors (e.g., cameras, video links) that can record (e.g., in real time) a surrounding environment. Here, view 400 shows a surrounding environment of a humanoid robot, as well an object (“box”) and command tasks (“pick up” and “move”).

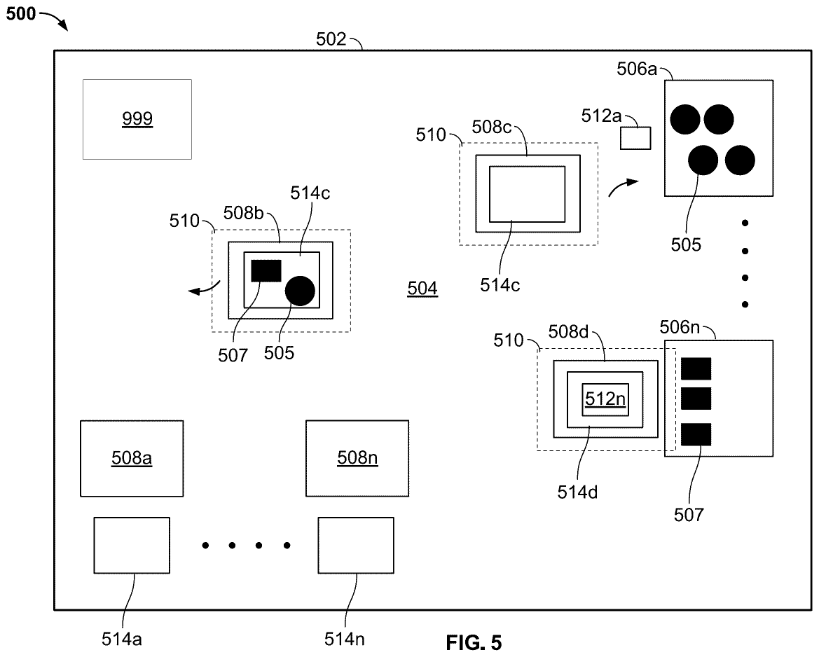

FIG. 5 is a schematic illustration of an example implementation of a workflow in a commercial environment 500 that includes an autonomous order picker lift trucks (either based on an autonomous mobile robot or an autonomous guided vehicle) and humanoid robots according to the present disclosure. For example, commercial environment 500 can be a warehouse (in any industry) or other facility (construction warehouse, shipping center, packaging center, warehouse, distribution or fulfillment center, manufacturing facility or otherwise) in which one or more commercial products (i.e., products sold or otherwise transferred in commerce) are gathered and stored (at least transiently) and arranged in combinations for sale, shipping, further distribution channels, or packaging. The workflow illustrated and described in FIG. 5 can represent a case pick at height process that integrates humanoid robots 512a-n and autonomous order picker lift trucks 508a-n to solve existing issues with existing case pick at height processes regardless of if those processes leverage humans along with conventional order picker lift trucks. The example workflow that integrates humanoid robots 512a-n and autonomous order picker lift trucks 508a-n can eliminate or reduce the need for humans to pick cases at height.

In particular, in example implementations, a case picking process can include operations performed at different heights (or distances) above a support surface (e.g., the floor, mezzanine, or otherwise) of a commercial environment. Thus, the cases may need to be picked from different vertical levels of pallet racking. In conventional case picking workflows in which humans perform the case picking operations, a human leverages an order picker lift truck to move through aisles of pallet racking that contain donor pallets at different heights and pick cases or boxes from the donor pallets to either build an order pallet or a receiving pallet of cases or boxes that will be shipped individually or in quantities less than an order pallet. However, such conventional systems also suffer from problems associated with the use of human case pickers, including injuries (or worse) to the human pickers that operate at heights (dangerous or otherwise) above the support surface.

Autonomous order picker lift trucks, which can be extensions or developments of autonomous reach trucks or autonomous VNA (very narrow aisle) trucks, can be used instead of human-controlled order picker lift trucks to eliminate the need for a human to drive the order picker to and from an aisle as well as control both horizontal and vertical operation of the order picker. But this does not eliminate the need for a human to pick cases (at height) and place on a donor or receiving pallet.

Example implementations according to the present disclosure provide for a case picking at height process that integrates humanoid robots (e.g., full bi-ped humanoid robots or the torso of the humanoid robot) along with autonomous non-humanoid robots, such as autonomous order picker lift trucks, to provide a better solution than existing person-to-goods case picking at height processes.

For example, with a case picking at height process that integrates humanoid robots and autonomous order picker lift trucks, a humanoid robot (e.g., either a full bi-ped humanoid robots or the torso of the humanoid robot mounted on the autonomous order picker lift truck, or a combination thereof) is autonomously transported to the correct donor pallet by the autonomous order picker lift truck. In some aspects, a Warehouse Management System (WMS) or Warehouse Execution System (WES) directs the autonomous order picker lift truck with a correct sequence of donor pallets to pick cases in a correct order so that the cases can be layered correctly on a pallet (heavy cases on the bottom or departmental-based loading as examples).

A WMS or WES directs the humanoid robot to pick a specific number of cases from a donor pallet and place on the pallet on the autonomous order picker lift truck. Either the WMS or WES software, or the software platform associated with the humanoid robot, will direct the proper placement of each case on the order pallet to create the correct layers on the order or receiving pallet. After picking and placing the appropriate number of cases in the correct location(s) on the order or receiving pallet, the autonomous order picker lift truck repositions itself and the humanoid robot to the next pick location where the process repeats across several pick locations until the order or receiving pallet is completed. Example implementations of a picking at height process that integrates humanoid robots with autonomous order picker lift trucks fully automates the case picking at height process and eliminates the dangerous work of humans picking at height while also ensuring that cases are layered in the proper order on order or receiving pallets.

As shown in FIG. 5, commercial environment 500 (such as a warehouse) includes or encloses an occupiable volume 504 in a building structure 502. The volume 504 can store donor pallets 506a-n (with “n” representing a variable number according to the present disclosure), for example, on a ground surface, pallet racking, or shelving. Each donor pallet 506a-n can enclose, contain, or otherwise support one or more commercial products. In some aspects, each donor pallet 506a-n supports a particular, unique commercial product (e.g., in a large quantity). For example, as shown, donor pallet 506a supports commercial products 505, while donor pallet 506n supports commercial products 507. There can be as many donor pallets 506a-n and commercial products as desired or necessary.

As shown in this example, one or more humanoid robots 512a-n are positioned in the volume 504, such as proximate to (e.g., within 1 ft., 2 ft., 3 ft., 4 ft., 5-10 ft., or otherwise) the donor pallets 506a-n. In some aspects, there can be a one-to-one ratio of humanoid robots 512a-n to donor pallets 506a-n. Alternatively, there can be more humanoid robots 512a-n than donor pallets 506a-n (e.g., more than one humanoid robot 512a-n can be positioned adjacent or assigned to a particular donor pallet 506a-n). Alternatively, there can be fewer humanoid robots 512a-n than donor pallets 506a-n (e.g., a particular humanoid robot 512a-n can be positioned adjacent or assigned to more than one donor pallet 506a-n). Generally, each humanoid robot 512a-n is operable to move to remove one or more commercial products from a particular donor pallet 506a-n (or more than one donor pallet) and, as described herein, place the removed commercial product(s) onto an order pallet.

In this example, one or more autonomous order picker lift trucks 508a-n are also positioned in the volume 504 and operable to move throughout the volume 504 to receive commercial products (505, 507, or others) onto order pallets 514a-n. In this example, one or more of autonomous order picker lift trucks 508a-n includes an order pallet or otherwise have an order pallet 514a-n placed onto the autonomous order picker lift trucks (either by its own actions or by a human operator). Each order pallet 514a-n can have a specified or predetermined quantity and type of commercial products to be placed on the order pallet according to a commercial transaction that has been (or will be) completed. As shown in this example, each autonomous order picker lift trucks 508a-n includes a safety field 510, which represents a volume surrounding the particular autonomous order picker lift trucks into which other objects (such as humanoid robots 512a-n) should not enter (e.g., for safety or other reasons).

In the present disclosure, one or more of the autonomous order picker lift trucks 508a-n can be an autonomous mobile robot (AMRs). As another example, one or more of the autonomous robots 508a-n can be an autonomous guided vehicle (AGV). Most likely, an autonomous order picker lift trucks will be a variant of an autonomous reach truck or autonomous VNA reach truck. In some aspects, AMRs can be distinguished from AGVs based on, for example, a level of autonomy of movement within the volume 504. For example, an AMR can be capable of full autonomous movement through the volume 504 such as by mapping the volume 504 and freely moving through the volume 504 based on the mapping. An AGV, however, may, in some aspects, move through the volume 504 on a guide wire that is positioned in the volume 504 (e.g., within a floor). Thus, the AGV may follow the guide wire through aisles of the volume 504 but, when not in the aisles, will wait on any object around it to move instead of navigating on a different path.

One or more of the autonomous robots 508a-508n are autonomous order picker lift trucks, which can autonomously (at least partially) operate to move through the volume 504. In some aspects, as explained more fully herein, a humanoid robot 512n can autonomously position itself on a platform of autonomous order picker lift truck 508d and be raised above a support surface (such as the floor of the building structure 502) to pick commercial product 507 from a case or multiple cases (or specific products within a case) on an elevated donor pallet 506n (e.g., positioned on a rack structure above the floor). Once picked, the lift truck 508d can return the humanoid robot 512n to the support surface, autonomously move the humanoid robot 512n to another vertical level in the volume 504 (e.g., a higher level) to pick additional cases, autonomously move the humanoid robot 512n to another location in the volume 504 (e.g., at the same vertical level), or other operation.

In this example workflow, the commercial environment 500 can include a Warehouse Management System (WMS) 999 that can, in some aspects, include, interface with, or incorporate a Warehouse Execution System (WES), a Warehouse Control System (WCS), and/or WES (or pick path optimization) functionality. Other functionality can be included with or interface with the WMS 999, such as cubing (or so-called “Tetris”) functionality, which allows the WMS 999 to instruct the humanoid robots 512a-n how and in what order to place product on one or more pallets (e.g., based on size and/or weight of the product, an order of removal of the product from the pallet such as last on-first off, an arrangement of the unloaded product within a store or other commercial enterprise, or a combination thereof).

The WMS 999, WES or WCS can be, for example, a microprocessor based control system that controls the operations of the humanoid robots 512a-n and autonomous robots 508a-n according to software instructions executable by the WMS 999, WES or WCS. In some aspects, the WMS 999, WES or WCS controls operations of the humanoid robots 512a-n and autonomous robots 508a-n to move commercial products (505, 507, and others) from donor pallets 506a-n to order pallets 514a-n (e.g., in specified quantities and in a specified order of loading) in order to fulfill a commercial transaction or otherwise. In some aspects, WMS 999, WES or WCS can be a physically separate control system that communicates (e.g., wired or wirelessly) with the humanoid robots 512a-n and autonomous robots 508a-n. Alternatively, some or all of the functionality (e.g., processing capability, memory storage, communications, software instructions) can be located in one or more of the humanoid robots 512a-n (such as, for example, within a head or torso of a humanoid robot). Thus, in some aspects, one or more of the humanoid robots 512a-n can act as the WMS 999 to control the humanoid robots 512a-n and autonomous robots 508a-n.

In some aspects of an example workflow of commercial environment 500, the WMS 999, WES or WCS can identify or register all of the humanoid robots 512a-n and autonomous robots 509a-n within the volume 504 (e.g., in order to determine which of the robots are activated or operable). The WMS 999, WES or WCS can then communicate with autonomous robot 508c and direct autonomous robot 508c toward the donor pallets 506a (e.g., in some cases, subsequent to picking up an empty order pallet 514a-n) in order to load an empty order pallet 514c with commercial products (505, 507, or others) to fulfill a specified transaction. In some aspects, the WMS 999, WES or WCS directs the autonomous robot 508c toward a particular donor pallet 506a-n (and subsequently to other donor pallets 506a-n in a specific order) based on a size or weight (or both) of the commercial product supported on the particular donor pallets 506a-n.

For example, in loading the empty order pallet 514c, it may be beneficial or advantageous to load commercial product heaviest (or largest) to lightest (or smallest) according to cubing functionality built into or interfaced with the WMS 999, WES or WCS. In such aspects, lighter commercial product may not be crushed or damaged by later-loaded and heavier commercial product. In some instances, the WMS can provide one or more autonomous robot 508a-n and/or one or more humanoid robots 512a-n one or more tasks. In some aspects, such as with the inclusion of cubing functionality, the WMS 999, WES or WCS can instruct, e.g., the humanoid robots 512a-n told to pick multiple cases and place them on a pallet, with a location specificity of placement on the pallet varying depending on the aforementioned criteria.

After the autonomous robot 508c is directed to a particular donor pallet, such as donor pallet 506a to pick up commercial product 505, the WMS 999 controls the humanoid robot 512a at the donor pallet 506a to pick a specific number of commercial product 505 from the donor pallet 506a and place the picked commercial product 505 onto the order pallet 514c. In some aspects, the WMS 999 directs the humanoid robot 512a to remain close to the donor pallet 506a until the autonomous robot 508c has stopped at a specific location to ensure that the humanoid robot 512a does not trigger the safety field 510 of the autonomous robot 508c. In some aspects, the WMS 999 or controller of the humanoid robot 512a (e.g., in the head or torso of the humanoid robot 512a) directs a proper placement of each commercial product 505 on the order pallet 514c to create the correct layers of product on the order pallet 514c. After picking and placing the appropriate number of commercial product 505 in the correct location(s) on the order pallet 514c, the humanoid robot 512a repositions itself close to the donor pallet 506a (e.g., at pallet racking or shelving) so that the autonomous robot 508c can leave the area around the donor pallet 506a without its safety field 510 being triggered.

The above-described operations can be repeated at one or more additional donor pallets 506a-n. For example, the autonomous robot 508c can next be directed to donor pallet 506n to pick up commercial product 507. If the order pallet 514c is complete, the autonomous robot 508c can move the order pallet 514c toward a location in the volume 504 in which the order pallet 514c can be shipped or otherwise packaged (e.g., as shown with autonomous robot 508b moving a completed order pallet 514b).

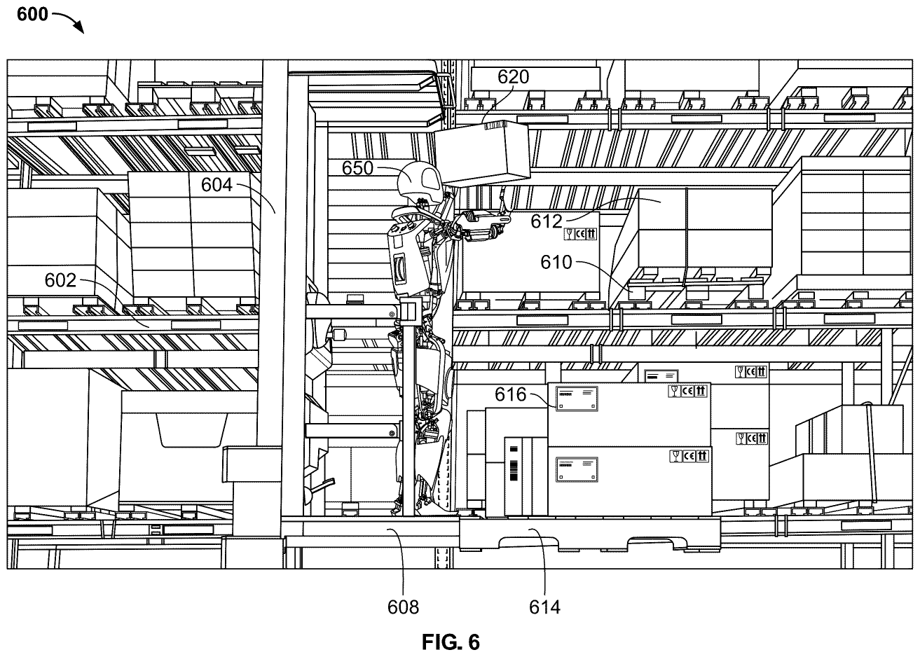

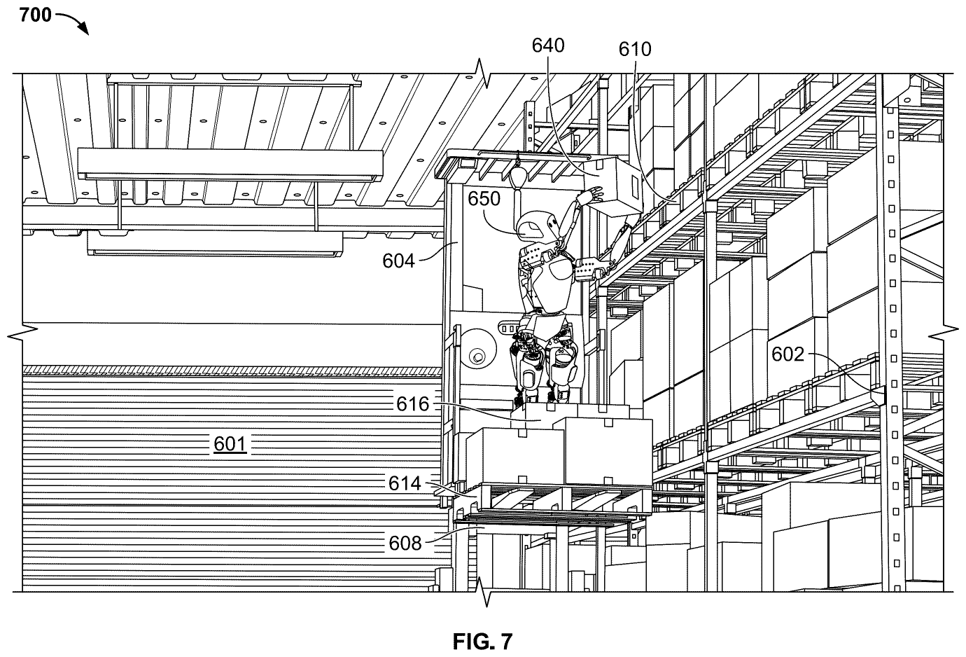

FIGS. 6 and 7 are schematic illustrations of views 600 and 700 of a commercial environment 601 that includes an autonomous mobile robot and a vertically elevated humanoid robot in a case picking workflow according to the present disclosure. As shown in FIG. 6, a humanoid robot 650 (which can be a full humanoid robot or torso humanoid robot) is positioned on a platform 608 of an autonomous order picker lift truck 604 that is operable to move through the environment 601 and adjust a vertical height of the platform 608 in order to adjust a vertical position of the humanoid robot 650. In this view 600, the autonomous order picker lift truck 604 has positioned the humanoid robot 650 adjacent a multi-level rack 602 in which multiple donor pallets 610 are supported. Each donor pallet 610 supports commercial product 612. As shown in this view 600, an order pallet 614 is also supported on the platform 608, with picked cases 616 on the pallet 614. Here, the humanoid robot 650 has been positioned by the autonomous order picker lift truck 604 at a certain height and at a certain location at the rack 602 to pick case 620 to put on the order pallet 614 that is being assembled.

As shown in FIG. 7, the humanoid robot 650 is positioned on the platform 608 of the autonomous order picker lift truck 604 at a different vertical height near the rack 602 as compared to the view 600. In this view 700, the autonomous order picker lift truck 604 has positioned the humanoid robot 650 adjacent the multi-level rack 602 to pick a case 640 from donor pallet 610. Once picked, the case 640 will be placed put on the order pallet 614 that is being assembled by the humanoid robot 650.

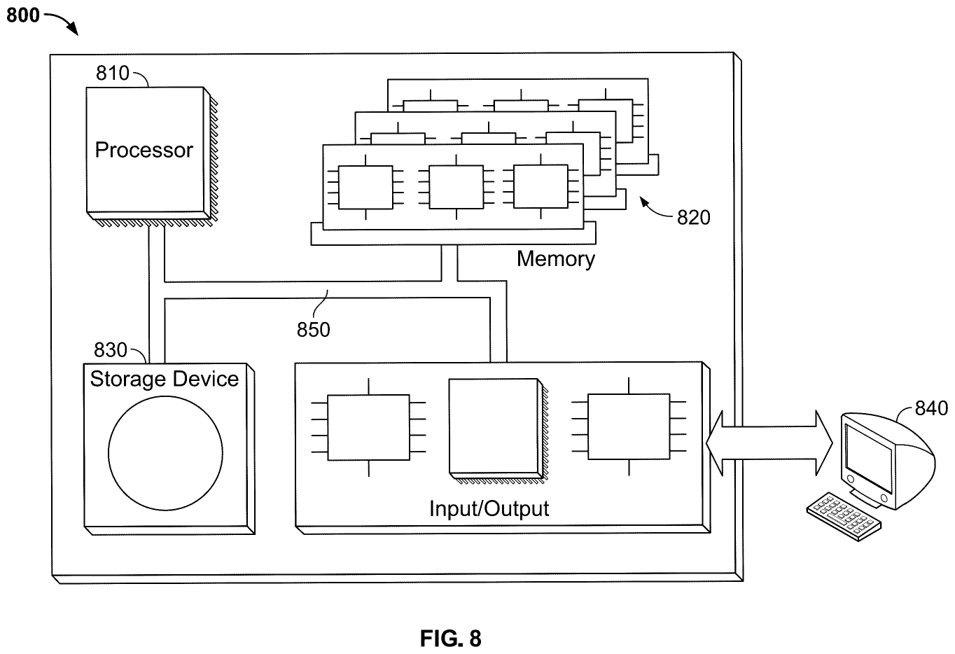

FIG. 8 shows a schematic drawing of a control system 800 that can be used in the example workflows of FIGS. 1 and 5 according to the present disclosure. For example, all or parts of the control system (or controller) 800 can be used for the operations described previously, for example as or as part of the Warehouse Management System (WMS) 999. Some or all of the example control system 800 (or WMS 900 generally) can be implemented as cloud-based system and/or service, alone or in combination with other portions of the example control system 800 that can be implemented at the commercial environment 100. The controller 800 is intended to include various forms of digital computers, such as printed circuit boards (PCB), processors, digital circuitry, or otherwise. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 800 includes a processor 810, a memory 820, a storage device 830, and an input/output device 840. Each of the components 810, 820, 830, and 840 are interconnected using a system bus 850. The processor 810 is capable of processing instructions for execution within the controller 800. The processor may be designed using any of a number of architectures. For example, the processor 810 may be a CISC (Complex Instruction Set Computers) processor, a RISC (Reduced Instruction Set Computer) processor, or a MISC (Minimal Instruction Set Computer) processor.

In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the control system 800. In one implementation, the memory 820 is a computer-readable medium. In one implementation, the memory 820 is a volatile memory unit. In another implementation, the memory 820 is a non-volatile memory unit.

The storage device 830 is capable of providing mass storage for the controller 800. In one implementation, the storage device 830 is a computer-readable medium. In various different implementations, the storage device 830 may be a floppy disk device, a hard disk device, an optical disk device, a tape device, flash memory, a solid state device (SSD), or a combination thereof.

The input/output device 840 provides input/output operations for the controller 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, for example, in a machine-readable storage device for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, solid state drives (SSDs), and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) or LED (light-emitting diode) monitor for displaying information to the user and a keyboard and a pointing device such as a mouse or a trackball by which the user can provide input to the computer. Additionally, such activities can be implemented via touchscreen flat-panel displays and other appropriate mechanisms.

The features can be implemented in a control system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

A number of implementations have been described. Nevertheless, it will be understood that various modifications may be made without departing from the spirit and scope of the disclosure. For example, example operations, methods, or processes described herein may include more steps or fewer steps than those described. Further, the steps in such example operations, methods, or processes may be performed in different successions than that described or illustrated in the figures. Accordingly, other implementations are within the scope of the following claims.

1. A robotic system, comprising:
one or more humanoid robots configured to move within a commercial environment that includes a plurality of commercial products supported by a plurality of donor pallets;
one or more autonomous mobile robots (AMRs) configured to move within the commercial environment; and
a control system communicably coupled to the one or more humanoid robots and the one or more AMRs, the control system configured to perform operations comprising:
commanding a particular AMR to move an order pallet within the commercial environment to a particular donor pallet; and
commanding a particular humanoid robot proximate to the particular donor pallet to move at least one commercial product from the particular donor pallet to the order pallet.

2. The robotic system of claim 1, wherein the operations further comprise:
commanding the particular AMR to move the order pallet within the commercial environment to another particular donor pallet; and
commanding another particular humanoid robot proximate to the another particular donor pallet to move at least one additional commercial product from the another particular donor pallet to the order pallet.

3. The robotic system of claim 2, wherein the at least one commercial product and the at least one additional commercial product are different.

4. The robotic system of claim 2, wherein the operations further comprise commanding the particular AMR to move the order pallet within the commercial environment away from the plurality of donor pallets subsequent to the another particular humanoid robot moving the at least one additional commercial product from the another particular donor pallet to the order pallet.

5. The robotic system of claim 1, wherein at least a portion of the control system is a part of the particular humanoid robot.

6. The robotic system of claim 5, wherein all of the control system is a part of the particular humanoid robot.

7. The robotic system of claim 5, wherein at least a portion of the control system is in a head of the particular humanoid robot.

8. The robotic system of claim 1, wherein each of the one or more humanoid robots comprises a torso and a lower body.

9. The robotic system of claim 8, wherein the torso comprises two arm appendages, two hand appendages, and a head, and the lower body comprises two leg appendages and two feet appendages.

10. The robotic system of claim 1, wherein the operations further comprise:
commanding the particular humanoid robot to stay within an area adjacent the particular donor pallet to avoid a safety field of the particular AMR.

11. The robotic system of claim 1, wherein the operations further comprise:
commanding another particular AMR to move another order pallet within the commercial environment to the particular donor pallet;
commanding the particular humanoid robot proximate to the particular donor pallet to move at least one commercial product from the particular donor pallet to the another order pallet;
commanding the another particular AMR to move the another order pallet within the commercial environment to the another particular donor pallet; and
commanding the another particular humanoid robot adjacent the another particular donor pallet to move at least one additional commercial product from the another particular donor pallet to the another order pallet.

12. The robotic system of claim 1, wherein the operations further comprise:
determining a path of the particular AMR through the commercial environment based on a combination of commercial products specified for the order pallet.

13. The robotic system of claim 12, wherein the operation of determining the path comprises:
determining a first commercial product of the combination of commercial products based on a weight or size of the first commercial product; and
determining a second commercial product of the combination of commercial products based on a weight or size of the second commercial product that is less than the weight or size of the first commercial product.

14. The robotic system of claim 13, wherein the operations further comprise:
(i) commanding the particular AMR to move the order pallet along the path within the commercial environment to the donor pallet that supports the first commercial product;
(ii) commanding the humanoid robot adjacent the donor pallet that supports the first commercial product to move at least one first commercial product to the order pallet;
(iii) subsequent to (ii), commanding the particular AMR to move the order pallet along the path within the commercial environment to the donor pallet that supports the second commercial product; and
(iv) commanding the humanoid robot adjacent the donor pallet that supports the second commercial product to move at least one second commercial product to the order pallet.

15. A computer-implemented method, comprising:
registering, with a control system, one or more humanoid robots within a commercial environment that includes a plurality of commercial products supported by a plurality of donor pallets;
registering, with the control system, one or more autonomous mobile robots (AMRs) within the commercial environment; and
commanding, with the control system, a particular AMR to move an order pallet within the commercial environment to a particular donor pallet; and
commanding, with the control system, a particular humanoid robot adjacent the particular donor pallet to move at least one commercial product from the particular donor pallet to the order pallet.

16. The computer-implemented method of claim 15, further comprising:
commanding, with the control system, the particular AMR to move the order pallet within the commercial environment to another particular donor pallet; and
commanding, with the control system, another particular humanoid robot adjacent the another particular donor pallet to move at least one additional commercial product from the another particular donor pallet to the order pallet.

17. The computer-implemented method of claim 15, wherein the at least one commercial product and the at least one additional commercial product are different.

18. The computer-implemented method of claim 16, further comprising commanding, with the control system, the particular AMR to move the order pallet within the commercial environment away from the plurality of donor pallets subsequent to the another particular humanoid robot moving the at least one additional commercial product from the another particular donor pallet to the order pallet.

19. The computer-implemented method of claim 15, wherein at least a portion of the control system is a part of the particular humanoid robot.

20. The computer-implemented method of claim 19, wherein all of the control system is a part of the particular humanoid robot.

21. The computer-implemented method of claim 19, wherein at least a portion of the control system is in a head of the particular humanoid robot.

22. The computer-implemented method of claim 15, wherein each of the one or more humanoid robots comprises a torso and a lower body.

23. The computer-implemented method of claim 22, wherein the torso comprises two arm appendages, two hand appendages, and a head, and the lower body comprises two leg appendages and two feet appendages.

24. The computer-implemented method of claim 15, further comprising:
commanding, with the control system, the particular humanoid robot to stay within an area adjacent the particular donor pallet to avoid a safety field of the particular AMR.

25. The computer-implemented method of claim 15, further comprising:
commanding, with the control system, another particular AMR to move another order pallet within the commercial environment to the particular donor pallet;
commanding, with the control system, the particular humanoid robot adjacent the particular donor pallet to move at least one commercial product from the particular donor pallet to the another order pallet;
commanding, with the control system, the another particular AMR to move the another order pallet within the commercial environment to the another particular donor pallet; and
commanding, with the control system, the another particular humanoid robot adjacent the another particular donor pallet to move at least one additional commercial product from the another particular donor pallet to the another order pallet.

26. The computer-implemented method of claim 15, further comprising:
determining, with the control system, a path of the particular AMR through the commercial environment based on a combination of commercial products specified for the order pallet.

27. The computer-implemented method of claim 26, wherein the operation of determining the path comprises:
determining, with the control system, a first commercial product of the combination of commercial products based on a weight or size of the first commercial product; and
determining, with the control system, a second commercial product of the combination of commercial products based on a weight or size of the second commercial product that is less than the weight or size of the first commercial product.

28. The computer-implemented method of claim 27, further comprising:
(i) commanding, with the control system, the particular AMR to move the order pallet along the path within the commercial environment to the donor pallet that supports the first commercial product;
(ii) commanding, with the control system, the humanoid robot adjacent the donor pallet that supports the first commercial product to move at least one first commercial product to the order pallet;
(iii) subsequent to (ii), commanding, with the control system, the particular AMR to move the order pallet along the path within the commercial environment to the donor pallet that supports the second commercial product; and
(iv) commanding, with the control system, the humanoid robot adjacent the donor pallet that supports the second commercial product to move at least one second commercial product to the order pallet.

29-52. (canceled)
